(19) United States
(12) Patent Application Publication
(10) Pub. No.: US 2025/0030604 A1
(43) Pub. Date: Jan. 23, 2025

(54) OPERATION METHOD OF USER PLANE MANAGEMENT FUNCTION IN SERVICE-BASED INTERFACE

(71) Applicant: ELECTRONICS AND TELECOMMUNICATIONS RESEARCH INSTITUTE, Daejeon (KR)

(72) Inventors: Quang Tung THAI, Daejeon (KR); Namseok KO, Daejeon (KR)

(21) Appl. No.: 18/775,971

(22) Filed: Jul. 17, 2024

(30) Foreign Application Priority Data
Jul. 17, 2023 (KR) 10-2023-0092647
Mar. 15, 2024 (KR) 10-2024-0036118

(51) Int. Cl. H04L 41/0895; H04L 41/0806; H04L 67/142; H04W 60/00

(52) U.S. Cl. CPC H04L 41/0895; H04L 41/0806; H04L 67/142; H04W 60/00

(57) ABSTRACT

Proposed is a network function for UPF management in a mobile communication system. The network function includes a memory configured to store at least one program therein, a transceiver configured to transmit and receive at least one signal, and a processor configured to execute the at least one program stored in the memory, wherein the processor is configured to register at least one UPF on the basis of a network slice, receive a UPF selection-related query message from an SMF, compute a UPF path on the basis of the query message, and forward, to the SMF, a response including the computed UPF path.

### CROSS REFERENCE TO RELATED APPLICATIONS

The present application claims priorities to Korean Patent Application Nos. 10-2023-0092647, filed 17 Jul. 2023, and 10-2024-0036118, filed 15 Mar. 2024, the entire contents of which are incorporated herein for all purposes by this reference.

### BACKGROUND OF THE INVENTION

### Field of the Invention

The present disclosure relates to an operation method of a user plane management function (UPMF) in a service-based interface (SBI).

The present disclosure relates to a method of setting a new type of access and mobility management function (AMF) on the basis of an SBI.

### Description of the Related Art

With the advent of new services, such as 5G, cloud computing, and the Internet of things (IoT), future application services require a network technology for providing more powerful programmability and a simpler integrated network solution. 5G was developed on the basis of service scenarios of Enhanced Mobile Broadband (eMBB), massive Machine Type Communication (mMTC), and Ultra-Reliable Low Latency Communications (uRLLC).

However, there is a growing need for providing various types of services. In addition, existing architectures may have limitations in providing complex services. Considering the above, a service-based architecture (SBA) may be regarded as a new architecture. For example, an SBA network may integrate the most advanced technologies such as network function virtualization (NFV), software-defined networking (SDN), multi-access edge computing (MEC), and network slicing, which will be described later.

The foregoing is intended merely to aid in the understanding of the background of the present disclosure, and is not intended to mean that the present disclosure falls within the purview of the related art that is already known to those skilled in the art.

### SUMMARY OF THE INVENTION

An embodiment may provide an integrated network solution with an SBI.

An embodiment may provide a method of registering and unregistering at least one user plane function (UPF) in and from a UPMF on the basis of a network slice.

An embodiment may provide a method of managing UPF topology by a UPMF on the basis of a network slice.

An embodiment may provide SBI-based operation methods of a default AMF (DAMF), a proxy radio access network (proxy RAN or PRAN), and a new version AMF (NAMF).

An embodiment may provide an SBI-based method of deriving the shortest path on the basis of UPF topology and forwarding the shortest path by a UPMF.

According to an embodiment, there is provided a network function for user plane function (UPF) management in a mobile communication system, the network function including: a memory configured to store at least one program therein; a transceiver configured to transmit and receive at least one signal; and a processor configured to execute the at least one program stored in the memory, wherein the processor is configured to register at least one UPF on the basis of a network slice, receive a UPF selection-related query message from a session management function (SMF), compute a UPF path on the basis of the query message, and forward, to the SMF, a response including the computed UPF path.

In addition, according to an embodiment, there is provided a user plane function (UPF) management method performed by a network function in a mobile communication system, the method including: registering at least one UPF on the basis of a network slice; receiving a UPF selection-related query message from a session management function (SMF); computing a UPF path on the basis of the query message; and forwarding, to the SMF, a response including the computed UPF path.

An embodiment can provide an integrated network solution with an SBI.

An embodiment can provide a method of registering and unregistering at least one UPF in and from a UPMF on the basis of a network slice.

An embodiment can provide a method of managing UPF topology by an on the basis of an SBI by a UPMF.

An embodiment can provide SBI-based operation methods of a DAMF, a PRAN, and an NAMF.

An embodiment can provide an SBI-based method of deriving the shortest path on the basis of UPF topology and forwarding the shortest path by a UPMF.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a conceptual diagram illustrating a mobile communication system according to an embodiment;

FIG. 2 is a diagram illustrating a device configuration according to an embodiment;

FIG. 3 is a diagram illustrating reference points according to an embodiment;

FIG. 4 is a diagram illustrating interactions between a network function and a service controller according to an embodiment;

FIGS. 5A and 5B are diagrams illustrating an operation method based on a service-based interface according to an embodiment;

FIG. 6 is a diagram illustrating a PDU session establishment procedure according to an embodiment;

FIGS. 7A and 7B are diagrams illustrating a method of managing a UPF on the basis of a UPMF according to an embodiment;

FIG. 8 is a diagram illustrating a method in which a UPF is registered in a UPMF and the UPMF provides a UPF path computation response according to an embodiment;

FIGS. 9A, 9B, and 9C are diagrams illustrating operation methods of an SMF, a UPF, and a UPMF based on an SBI according to an embodiment of the present disclosure;

FIG. 10 is a diagram illustrating a method of managing UPFs on the basis of a UPMF according to an embodiment of the present disclosure;

FIGS. 11A and 11B are diagrams illustrating a method of configuring network functions on the basis of a service-based interface applicable to the present disclosure;

FIG. 12 is a diagram illustrating a method of performing registration based on a service-based interface by a terminal applicable to the present disclosure;

FIG. 13 is a diagram illustrating a general network function design according to an embodiment; and

FIG. 14 is a flowchart illustrating an operation method of a network function according to an embodiment.

### DETAILED DESCRIPTION OF THE INVENTION

Hereinbelow, exemplary embodiments of the present disclosure will be described in detail with reference to the accompanying drawings such that the present disclosure can be easily embodied by those skilled in the art to which this present disclosure belongs. However, the present disclosure may be embodied in various different forms and should not be limited to the embodiments set forth herein. Further, in order to clearly explain the present disclosure, portions that are not related to the present disclosure are omitted in the drawings, and like reference numerals designate like elements throughout the specification.

Throughout the specification, a terminal may refer to a user equipment (UE), a mobile station (MS), a mobile terminal (MT), an advanced mobile station (AMS), a high-reliability mobile station (HR-MS), a subscriber station (SS), a portable subscriber station (PSS), an access terminal (AT), or a machine type communication device (MTC device), or may include all or some functions of the UE, MS, MT, AMS, HR-MS, SS, PSS, or AT.

In addition, a base station (BS) may refer to a node B, an evolved node B (eNB), a gNB, an advanced base station (ABS), a high-reliability base station (HR-BS), an access point (AP), a radio access station (RAS), a base transceiver station (BTS), a mobile multi-hop relay (MMR)-BS, a relay station (RS) acting as a base station, a relay node (RN) acting as a base station, an advanced relay station (ARS) acting as a base station, a high-reliability relay station (HR-RS) acting as a base station, or a small base station (a femto BS, a home node B (HNB), a home eNodeB (HeNB), a pico BS, a macro BS, a micro BS), etc.), or may include all or some functions of the NB, eNB, gNB, ABS, AP, RAS, BTS, MMR-BS, RS, RN, ARS, HR-RS, or small base station.

Throughout the specification, when a part “includes” an element, it is noted that it further includes other elements, but does not exclude other elements, unless specifically stated otherwise.

In the specification, each of the expressions “A or B”, “at least one of A and B”, “at least in one of A or B”, “A, B, or C”, “at least one of A, B, and C”, and “at least one of A, B, or C” may include any one of the items listed together in that expression, or may include any possible combinations thereof.

In the specification, a term described in the singular may be interpreted as singular or plural unless an explicit term such as “one” or “single” is used.

In the specification, the term “and/or” includes each of the recited elements, and any combinations of one or more elements.

In the specification, the terms including ordinal numbers, such as “first”, “second”, etc., may be used to describe various elements, but the elements are not to be construed as being limited to the terms. The terms are only used to differentiate one element from other elements. For example, the “first” element may be named the “second” element without departing from the scope of the present disclosure, and the “second” element may also be similarly named the “first” element.

In the flowcharts described in the specification with reference to the drawings, the order of the steps may be changed, several steps may be merged, some steps may be divided, or particular steps may not be performed.

A communication network to which embodiments of the present disclosure are applied will be described. A communication network may be a 4G communication network (e.g., a long-term evolution (LTE) communication network), a 5G communication network (e.g., a new radio (NR) communication network), or a non-terrestrial network (NTN). Throughout the specification, examples of a network may include, for example, a wireless Internet such as wireless fidelity (Wi-Fi); a mobile Internet such as wireless broadband Internet (WiBro) or world interoperability for microwave access (WiMax); a 2G mobile communication network such as global system for mobile communication (GSM) or code-division multiple access (CDMA); a 3G mobile communication network such as wideband code-division multiple access (WCDMA) or CDMA2000; a 3.5G mobile communication network such as high speed downlink packet access (HSDPA) or high speed uplink packet access (HSUPA); a 4G mobile communication network such as a long-term evolution (LTE) network or an LTE-Advanced network; and a 5G mobile communication network.

Throughout the specification, a terminal may be referred to as a terminal, an access terminal, a mobile terminal, a station, a subscriber station, a mobile station, a portable subscriber station, a node, or a device.

Herein, as a terminal, the following devices capable of communication may be used: a desktop computer, a laptop computer, a tablet personal computer (PC), a wireless phone, a mobile phone, a smartphone, a smart watch, smart glasses, an e-book reader, a portable multimedia player (PMP), a portable gaming device, a navigation device, a digital camera, a digital multimedia broadcasting (DMB) player, a digital audio recorder, a digital audio player, a digital picture recorder, a digital picture player, a digital video recorder, and a digital video player.

Throughout the specification, a base station may be referred to as a Node B, an evolved Node B, a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), or a relay node.

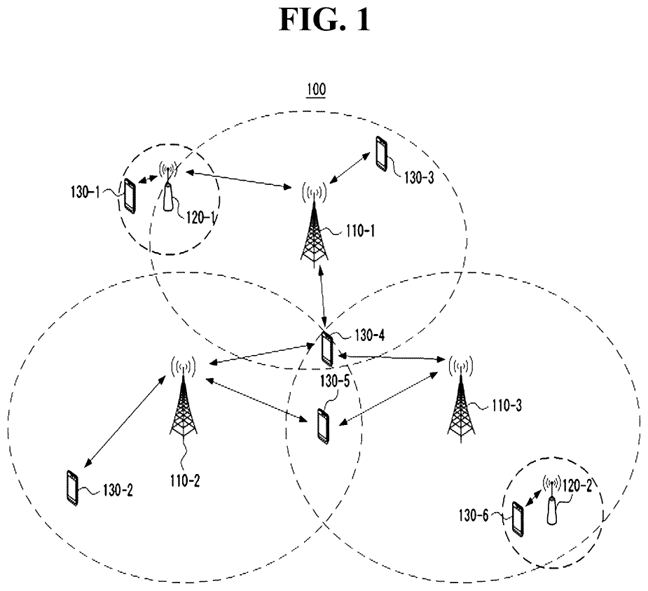

FIG. 1 is a conceptual diagram illustrating a mobile communication system according to an embodiment.

Referring to FIG. 1, a communication system 100 may include a plurality of communication nodes 110-1, 110-2, 110-3, 120-1, 120-2, 130-1, 130-2, 130-3, 130-4, 130-5, and 130-6. The plurality of communication nodes may support 4G communications (e.g., long-term evolution (LTE), LTE-A (advanced)), and 5G communications (e.g., new radio (NR)) defined by the 3rd generation partnership project (3GPP) standards. The 4G communications may be performed in the frequency band of 6 GHz or below, and the 5G communications may be performed in the frequency band of 6 GHz below as well as the frequency band of 6 GHz above.

For example, for the 4G communications and 5G communications, the plurality of communication nodes may support the following protocols: a code-division multiple access (CDMA)-based communication protocol, a wideband CDMA (WCDMA)-based communication protocol, a time-division multiple access (TDMA)-based communication protocol, a frequency-division multiple access (FDMA)-based communication protocol, an orthogonal frequency-division multiplexing (OFDM)-based communication protocol, a filtered OFDM-based communication protocol, a cyclic prefix (CP)-OFDM based communication protocol, a discrete Fourier transform-spread-OFDM (DFT-s-OFDM)-based communication protocol, an orthogonal frequency-division multiple access (OFDMA)-based communication protocol, a single carrier (SC)-FDMA-based communication protocol, a non-orthogonal multiple access (NOMA)-based communication protocol, a generalized frequency-division multiplexing (GFDM)-based communication protocol, a filter bank multi-carrier (FBMC)-based communication protocol, a universal filtered multi-carrier (UFMC)-based communication protocol, and a space-division multiple access (SDMA)-based communication protocol.

In addition, the communication system 100 may further include a core network. When the communication system 100 supports the 4G communications, the core network may include a serving-gateway (S-GW), a packet data network (PDN)-gateway (P-GW), and a mobility management entity (MME). When the communication system 100 supports the 5G communications, the core network may include a user plane function (UPF), a session management function (SMF), and an access and mobility management function (AMF).

In the meantime, each of the plurality of communication nodes 110-1, 110-2, 110-3, 120-1, 120-2, 130-1, 130-2, 130-3, 130-4, 130-5, and 130-6, or network functions constituting the communication system 100 may have the following structure.

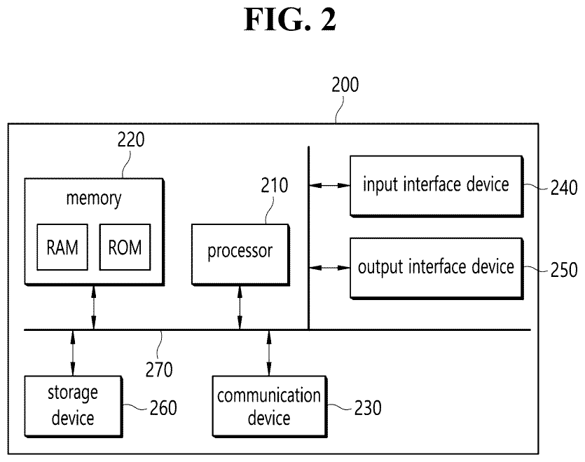

FIG. 2 is a diagram illustrating a device configuration according to an embodiment. Referring to FIG. 2, a communication node 200 (network function) may include at least one processor 210, a memory 220, and a communication device 230 that is connected to a network to perform communication. In addition, the communication node 200 may further include an input interface device 240, an output interface device 250, and a storage device 260. Each of the elements included in the communication node 200 may be connected by a bus 270 to communicate with each other.

However, with the processor 210 in the center, each of the elements included in the communication node 200 may be connected via an individual interface or an individual bus, rather than the common bus 270. For example, the processor 210 may be connected via a dedicated interface to at least one selected from the group of the memory 220, the communication device 230, the input interface device 240, the output interface device 250, and the storage device 260.

The processor 210 may execute program commands stored in either the memory 220 or the storage device 260 or both. The processor 210 may refer to a central processing unit (CPU), a graphics processing unit (GPU), or a dedicated processor on which methods according to embodiments of the present disclosure are performed. Each of the memory 220 and the storage device 260 may include either a volatile storage medium or a non-volatile storage medium or both. For example, the memory 220 may include either read-only memory (ROM) or random-access memory (RAM) or both.

Referring back to FIG. 1, the communication system 100 may include a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an “access network”. Each of a first base station 110-1, a second base station 110-2, and a third base station 110-3 may form a macro cell. Each of a fourth base station 120-1 and a fifth base station 120-2 may form a small cell. The fourth base station 120-1, a third terminal 130-3, and a fourth terminal 130-4 may fall within the cell coverage of the first base station 110-1. A second terminal 130-2, the fourth terminal 130-4, and a fifth terminal 130-5 may fall within the cell coverage of the second base station 110-2. The fifth base station 120-2, the fourth terminal 130-4, the fifth terminal 130-5, and a sixth terminal 130-6 may fall within the cell coverage of the third base station 110-3. A first terminal 130-1 may fall within the cell coverage of the fourth base station 120-1. The sixth terminal 130-6 may fall within the cell coverage of the fifth base station 120-2.

Herein, each of the plurality of base stations 110-1, 110-2, 110-3, 120-1, and 120-2 may be referred to as a Node B, an evolved Node B, a gNB, a base transceiver station (BTS), a radio base station, a radio transceiver, an access point, or an access node. Each of the plurality of terminals 130-1, 130-2, 130-3, 130-4, 130-5, and 130-6 may be referred to as a user equipment (UE), a terminal, an access terminal, a mobile terminal, a station, a subscriber station, a mobile station, a portable subscriber station, a node, or a device.

In the meantime, each of the plurality of base stations 110-1, 110-2, 110-3, 120-1, and 120-2 may operate in different frequency bands or the same frequency band. Each of the plurality of base stations 110-1, 110-2, 110-3, 120-1, and 120-2 may be connected to each other via an ideal backhaul link or a non-ideal backhaul link, and may exchange information with each other via the ideal backhaul link or the non-ideal backhaul link. Each of the plurality of base stations 110-1, 110-2, 110-3, 120-1, and 120-2 may be connected to the core network via an ideal backhaul link or a non-ideal backhaul link. Each of the plurality of base stations 110-1, 110-2, 110-3, 120-1, and 120-2 may transmit signals received from the core network to corresponding terminals 130-1, 130-2, 130-3, 130-4, 130-5, and 130-6, and may transmit signals received from the corresponding terminals 130-1, 130-2, 130-3, 130-4, 130-5, and 130-6 to the core network.

For example, a 5G system may include an architecture based on interactions between network functions (NFs). For example, as a core network of the 5G system, the 5GC may include various entities. Specifically, the access and mobility management function (AMF) may mange the access and mobility of a terminal. In addition, the AMF may perform a function of managing the security of a non-access stratum (NAS). In addition, the AMF may perform a function of handling the mobility of a terminal in an idle state.

In addition, the session management function (SMF) may manage a session. For example, the SMF may perform a function of assigning terminal Internet protocol (IP) addresses, and may control a protocol data unit (PDU) session.

In addition, the policy control function (PCF) may perform a function of controlling policy. In addition, a user plane function (UPF) performing a function of controlling a user plane may be included. The UPF may perform all or part of the user plane functions of the serving gateway (S-GW) and the packet data network gateway (P-GW) of the previous mobile communication system (4G) as a function of a gateway for transmitting and receiving data. In addition, the UPF may perform a function of handling the PDU. In addition, an application function (AF) controlling an application function may be included. The AF may be a function of providing a plurality of services to a terminal. In addition, a unified data management (UDM) managing integrated data may be included. Herein, the UDM may perform a function of managing subscriber information.

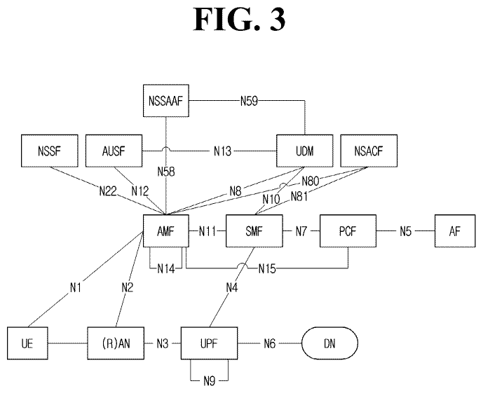

FIG. 3 is a diagram illustrating reference points according to an embodiment of the present disclosure. Referring to FIG. 3, a reference point may represent an interaction between NF services within NFs described by a point-to-point reference point between two network functions (NFs). For example, the N1 may be a reference point between the terminal (UE) and the access management function (AMF). The N2 may be a reference point between the (R)AN and the AMF. The N3 may be a reference point between the (R)AN and the user plane function (UPF). Other reference points may be as shown in Table 1 below, but may not be limited thereto.

```
TABLE 1
  N1: Reference point between the UE and the AMF.
  N2: Reference point between the (R)AN and the AMF.
  N3: Reference point between the (R)AN and the UPF.
  N4: Reference point between the SMF and the UPF.
  N5: Reference point between the PCF and an AF or TSN AF.
  N6: Reference point between the UPF and a Data Network.
  N7: Reference point between the SMF and the PCF.
  N8: Reference point between the UDM and the AMF.
  N9: Reference point between two UPFs.
  N10: Reference point between the UDM and the SMF.
  N11: Reference point between the AMF and the SMF.
  N12: Reference point between AMF and AUSF.
  N13: Reference point between the UDM and Authentication Server function the AUSF.
  N14: Reference point between two AMFs.
  N15: Reference point between the PCF and the AMF in the case of non-roaming scenario,
PCF in the visited network and AMF in the case of roaming scenario.
  N16: Reference point between two SMFs, (in roaming case between SMF in the visited
network and the SMF in the home network).
  N16a: Reference point between SMF and I-SMF.
  N17: Reference point between AMF and 5G-EIR.
  N18: Reference point between any NF and UDSF.
  N19: Reference point between two PSA UPFs for 5G LAN-type service.
  N22: Reference point between AMF and NSSF.
```

The 5G mobile core described above with reference to FIGS. 1 to 3 is designed as a single structure. However, in the post-5G environment (e.g., 6G), there is a need to design a core network with a service-based architecture. For example, a network may include network functions, which are software components operating on the basis of interactions, thus achieving horizontal scalability and flexibility to meet various specific requirements. In addition, a mobile core network may operate with mature cloud-native technology in which network functions are arranged in multiple distributed clouds. Herein, the current 5G mobile core structure has limitations in supporting cloud-native technology, so a paradigm shift may be required. Considering the above, a core network may be designed as a service-based architecture (SBA)-based network. The SBA-based core network may be included, being decomposed into network functions (NFs), which are software components having various functions. Herein, the NFs may expose services in the form of a restful application programming interface (API). That is, decomposing the network into NFs, which are software components, may allow flexible and scalable arrangements, and a service-based structure may thus be achieved. In addition, for example, in the SBA-based core network, the NFs may be containerized and arranged in multiple clouds, and cloud technology may enable resource sharing and dynamic allocation of service operations. Through the above, a flexible and scalable core network may be built, thereby providing various services.

For example, various types of services are expected to emerge in the post-5G environment, and considering the services, a core network needs to be designed on the basis of an SBA. Considering the above, an operation method in the SBA-based core network will be described below. Based on the current 5G core network, the signaling procedure for a terminal may be performed on the basis of an NF chain in such a manner that each NF processes some steps of the procedure. Each of the NFs may be connected via an interface as shown in Table 1 above. That is, the NFs may configure static connections between the NFs. However, automatic search may be required considering NF search and selection operations in a large-scale dynamic structure. For example, a network repository function (NRF) may exist in the current 5G core network, and an NF may be registered in the NRF. The NFs may transmit queries to the NRF to request services and may select other NFs through responses. Herein, for example, it is difficult to include service search and selection logic in each NF. Considering the above, a service communication proxy (SCP) may be used. The SCP may perform service search and selection, instead of the NFs, relieving the NFs of the burden of performing service search and selection themselves. However, even when the SCP performs service search and selection, the NFs needs to be registered in the NRF for search. That is, service search and selection may be performed in a centralized manner on the basis of the NRF. For example, centralized service search and selection may have limitations as it may cause bottlenecks in control plane traffic and multiple signal search procedures may cause delays.

Herein, in the post-5G environment, where service types are diverse and the number thereof increases, the SBA-based core network may be required in a new type, and the SBA-based core network may perform the functions of the NRF and SCP without the NRF and SCP. For example, in the case of the operation based on the SBA-based core network, a service agent and a service controller may perform selecting an appropriate instance of a target service within application program context, and common logic for NF search and selection may be included in the service agent. That is, all network functions may be connected to the service agent serving as a proxy that performs service request and response instead, and the service agent may perform any service registration/search and selection in the signal logic of the network functions.

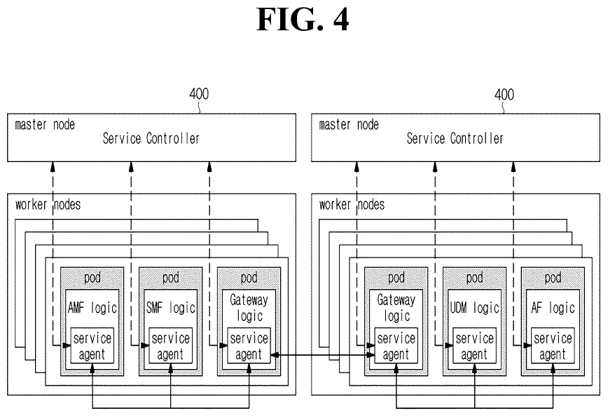

For example, FIG. 4 is a diagram illustrating service controllers and service agents according to an embodiment. Referring to FIG. 4, service controllers 400 may control service agents within individual NFs, and each service agent within the individual NFs may serve as a proxy that performs service request and response instead through interconnection.

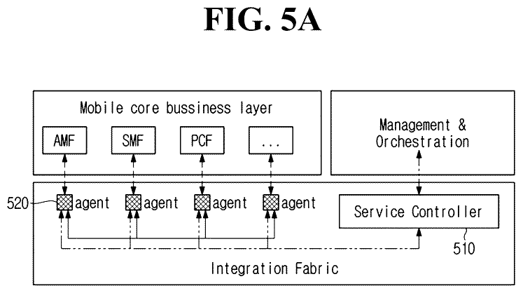

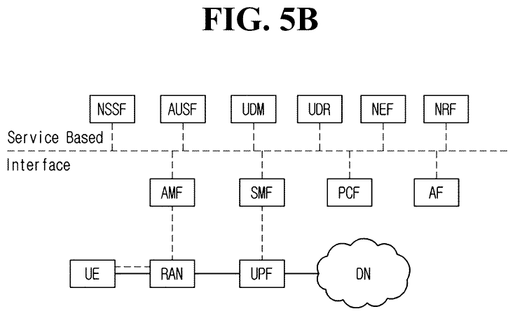

As a more specific example, referring to FIG. 5A, in a service-based architecture (SBA), a control plane of a 5G core network may include a plurality of network functions (NFs), and each of the network functions may perform a predetermined function. For example, the control plane may include a middleware layer of an integration fabric to reduce complexity. The integration fabric may include a service controller 510 and agents 520. Each of the network functions may be operated by directly using the agent 520 within an execution file for service routing. In the meantime, the service controller 510 may serve as a service registry for collecting information on respective locations and runtime environment parameters of the agents 520. In addition, the service controller 510 may define and configure routing functions of the agents through interaction with a management and orchestration layer. For example, the integration fabric may provide an integrated programming application programming interface (API) through the agents 520 to enable smooth interaction with a business layer including a core network function.

Referring to FIG. 5B, all network functions may be included in a service-based interface with an SBA. For example, a particular NF may provide a service to another approved NF, and may perform interaction through a client-server API. That is, an existing communication signal message may be replaced with an API call of a shared service bus. Compared to an existing communication system, modularity, scalability, stability, and cost efficiency may be improved, but no limitation thereto is imposed. For example, a major change in the SBA may be a shift from a point-to-point protocol to a consumer-producer communication paradigm. That is, in the related art, both a consumer and a producer need to set a communication channel with a point-to-point protocol in person, which may require prior knowledge of each other's existence and identifiers, limiting scalability. However, in the SBA, in a consumer-producer or a client-server model, a service consumer may search for an available appropriate network service through a service search and registration mechanism and obtain connection information. For example, the above-described operation may be realized by a network repository function (NRF), but is not limited thereto.

For example, in a current wireless communication system (e.g., 5G), a user plane and a control plane are separated. A user plane function (UPF) may serve as an anchor point for user data traffic in the network, but this may be impossible in the SBA. In the current wireless communication system, communication between the UPF and the session management function (SMF) may use a point-to-point protocol (e.g., N4). However, considering scalability and orchestration, the SBA structure may have limitations in operating based on the current wireless communication system. Considering the above, the SBA structure may need a method of managing a UPF efficiently. Hereinafter, the method will be described. In addition, an AMF operating on the basis of the SBA structure may be required and will be described.

For example, hereinafter, a user plane management function (UPMF) may be considered as a new network function of managing a UPF. The UPMF may monitor and manage UPFs that support working slices for heterogeneous types of services. Hereinafter, a specific method for this will be described.

For example, a UPF may provide a connection point between a mobile infrastructure and a data network. Specifically, in order to forward the application data flow of a terminal, there is a need to create and maintain a tunnel from the terminal to the data network. The UPF may perform this. Through the above, a wireless communication system may perform data transmission that satisfies low-latency and high-throughput conditions. In addition, separation between a control plane function and a user plane function may be easy on the basis of the UPF. As interfaces of the UPF, the following interfaces may be set: N3 interface, which is the interface between the RAN (gNB) and the UPF; N4 interface, which is the interface between the SMF and the UPF; N6 interface, which is the interface between the DN and the UPF; and N9 interface, which is the interface between two UPFs. Herein, the above-described interfaces may be point-to-point interfaces.

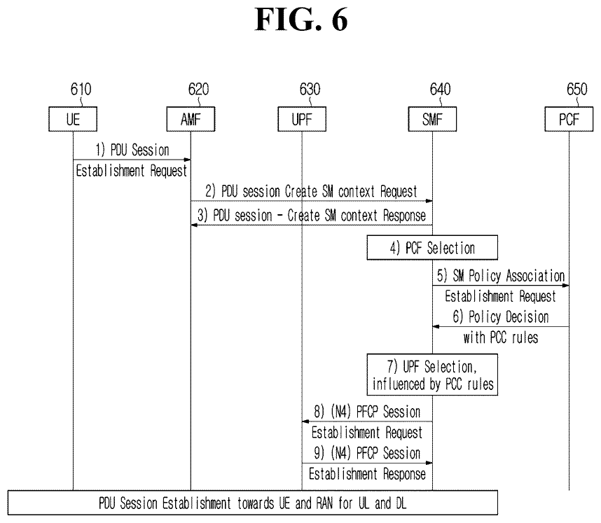

FIG. 6 is a diagram illustrating a PDU session establishment procedure applicable to the present disclosure. Referring to FIG. 6, a terminal 610 may perform connection to a network, registration, and authentication. Afterward, the terminal 610 may transmit a PDU session establishment request to an AMF 620 for PDU session establishment. On the basis of the PDU session establishment request obtained from the terminal 610, the AMF 620 may forward information required for PDU session establishment to an SMF 640. For example, on the basis of the PDU session establishment request, the AMF 620 may forward a PDU session-SM context creation request to the SMF 640, and in response thereto, may obtain a PDU session-SM context creation response. The SMF 640 may obtain PDU session establishment-related information from the AMF 620 and perform a procedure for selecting a PCF 650. The SMF 640 may determine the PCF 650 to be used for the terminal 610. For example, the SMF 640 may select the PCF 650 on the basis of information obtained from an NRF or local configuration. However, no limitation to the embodiment is imposed. Afterward, the SMF 640 may forward an SM policy association establishment request to the PCF 650 for session management policy connection creation. The SM policy association establishment request may include context information, such as a subscription permanent identifier (SUPI), a data network name (DNN), and network slice selection assistance information (NSSAI), but is not limited thereto. The PCF 650 may query a subscriber profile stored in the local configuration or a UDR to determine a policy corresponding to the SUPI, along with PCC rules. The SMF 640 may obtain the determined policy and PCC rules from the PCF 650, and may select at least one UPF on the basis of the policy and PCC rules. For example, when selecting an appropriate UPF, the SMF may use location information of the user to determine cell ID information or tracking area code (TAC) information. Afterward, the SMF 640 may select and configure the UPF on the basis of the N4 interface, and may indicate a method of routing traffic between the terminal and the data network. More specifically, the SMF 640 may forward information on network connection including an entity to be connected and a UE IP address, to the UPF. In addition, the SMF 640 may indicate, to the UPF, the method of routing the traffic between the terminal and the data network.

For example, the SMF may indicate, to the UPF, information on network entities to be connected. The information that the SMF indicates to the UPF may include information that identifies an intermediate UPF that may be involved in the data routing process and a base station to which the UPF needs to set a connection. The SMF may forward the information so that the network entities recognize each other. In addition, the SMF may provide the terminal IP address (UE IP address) to the UPF. Through this, the UPF may perform direct connection establishment with the terminal, and allow data packet exchange between the terminal and the data network. By providing the terminal IP address to the UPF, the SMF enables the UPF to recognize particular end point information required to route the traffic targeting the terminal. In addition, for example, the SMF may indicate, to the UPF, the method of routing the traffic between the terminal and the data network. The SMF may transmit information on a desired routing path and quality of service (QOS) parameters, thus enabling the UPF to join the intended path and process data packets.

In addition, for example, the SMF and the UPF connected on the basis of the N4 interface may set a packet forwarding control protocol (PFCP) to support separation between the control plane and the user plane. The SMF may forward the PFCP to at least one UPF, and may enable PDU sessions for the user plane to be continuously forwarded. However, the current N4 interface may have limitations in providing a service. As a specific example, in order to create connection, a UDP-based PFCP needs to recognize an IP address of an entity connected to an end point, and needs to obtain information about this. Herein, there may be a problem of distribution of the information. In the meantime, in the SBA, the life cycles of the SMF and the UPF are managed in a dynamic manner, and an application instance may be created or terminated by the orchestration layer. Herein, a physical address (IP) may not be fixed and temporary.

In addition, for example, when the number of UPFs and the number of network slices increase, the SMF may have limitations in managing and adjusting various UPFs through various network slices. Considering the above, there may be a need for a method of simultaneously managing various UPFs automatically and efficiently.

As another example, the case in which a plurality of SMFs maintain UPF topology may be considered. Specifically, a plurality of SMFs in different network slices may participate in management of a plurality of UPFs. That is, a plurality of different SMFs may manage a common UPF. Herein, when managing a common UPF, a plurality of SMFs need to have the same version of UPF topology. On the basis of this, the plurality of SMFs need to synchronize. In addition, when a UPF is managed by a plurality of SMFs, the entire system may be complex. Considering the above, there may be a need for a method of managing a UPF through an SBA structure-based UPMF, which will be described below.

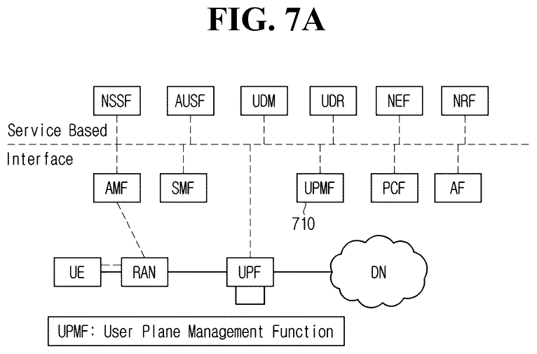

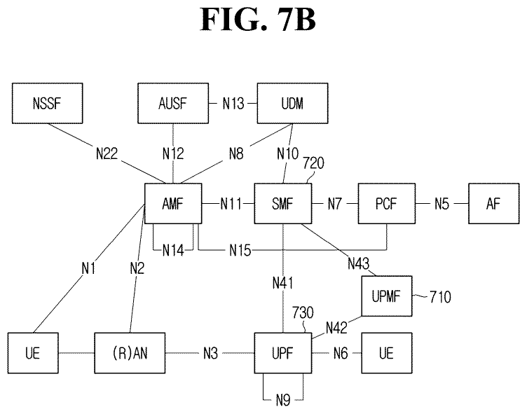

For example, the UPMF may serve as a registry for the SMF that manages a network UPF. The UPMF may compute an appropriate path (path/route) for terminal traffic forwarded through UPFs. The UPMF may be configured on the basis of the above-described SBI structure, which may be as shown in FIGS. 7A and 7B. Specifically, referring to FIG. 7A, a UPMF 710 may be configured in a service-based interface on the basis of the SBI structure.

As another example, referring to FIG. 7B, a UPMF 710 and an SMF 720 may configure N43 interface, the UPMF 710 and a UPF 730 may configure N42 interface, and the SMF 720 and the UPF 730 may configure N41 interface. For example, the above-described interface names are only an example, and without being limited thereto, the interfaces may be referred to as other names. That is, an interface may be configured between each of the UPMF 710, the SMF 720, and the UPF 730. For example, the UPMF 710 may store UPF topology information including all UPFs within an operating network slice. The UPMF 710 may include IP addresses corresponding to the respective all UPFs and link connection information between the UPFs. In addition, the UPMF 710 may have a path computation function for current embedded UPFs. For example, the UPMF 710 may replace the SMF-UPF N4 interface using the PFCP with the service-based interface using HTTP/HTTPS, but no limitation thereto is imposed. In addition, for example, when the UPMF 710 is configured with a new network function, an interface between the UPMF 710 and another network function may be further configured, but no limitation to a particular form is imposed.

Herein, for example, the UPMF may have UPF registration and UPF path query functions to provide the above-described services. Specifically, the UPMF may be a network function provided in all network slices, and the address of the UPMF may be recognized by all deployed UPFs. Therefore, when the operation of a UPF starts, the UPF may be registered in the UPMF on the basis of UPF information. For example, configuration information required when a UPF is registered in the UPMF may include a UPF identifier, a network slice in which the UPF is included, interface information, and other types of information. Herein, the interface information may include N3 interface between the RAN and the UPF, N6 interface between the UPF and the DN, and N9 interface between UPFs, but is not limited thereto. For example, when a change occurs in a UPF, the UPF may transmit update information to the UPMF. The UPMF may configure, on the basis of information received from a UPF, a topology map for all UPFs for each of the operating slices. In addition, all UPFs and base stations within the network may be assigned unique identifiers within deployment, and the above-described information may be forwarded to the UPMF and stored. In addition, the above-described information may be stored in an NFR, but no limitation to a particular form is imposed.

As another example, a UPF may be deregistered from the UPMF. As a specific example, a UPF may be deregistered from the UPMF when the UPF is unavailable or for other reasons. The UPMF may compute a path corresponding to a network slice, except the deregistered UPF. As another example, the UPMF may keep all registered UPFs registered and determine whether the registered UPFs are available. The UPMF may compute a path for a network slice on the basis of available UPFs among the registered UPFs, excluding unavailable UPFs.

In addition, the UPMF may receive a query message from the SMF. The query message may include NSSAI information, a source network interface as connected base station information, and a destination network interface card (NIC) as an anchoring UPF. The UPMF may configure a data structure to manage UPF topology of a slice corresponding to each piece of NSSAI. For example, the UPMF may search for, on the basis of the received query message, all paths that satisfy a query condition through a routing algorithm (e.g., Dijkstra algorithm). Afterward, the UPMF may select the shortest path and may include information on this in response information to forward the response information to the SMF.

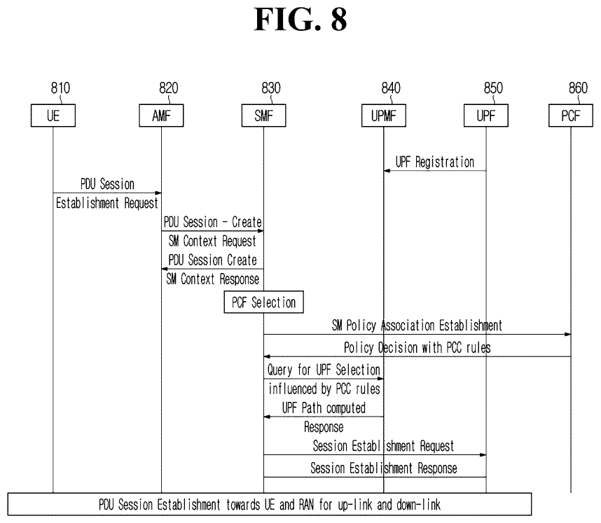

As a specific example, FIG. 8 is a diagram illustrating a method in which a UPF is registered in a UPMF and the UPMF provides a UPF path computation response according to an embodiment of the present disclosure. Referring to FIG. 8, a terminal 810 may forward a PDU session establishment request to an AMF 820. On the basis of the PDU session establishment request obtained from the terminal 810, the AMF 820 may forward information required for PDU session establishment to an SMF 830. For example, on the basis of the PDU session establishment request, the AMF 820 may forward a PDU session-SM context creation request to the SMF 830, and in response thereto, may obtain a PDU session-SM context creation response. The SMF 830 may obtain PDU session establishment-related information from the AMF 820 and perform a procedure for selecting a PCF 860. The SMF 830 may determine the PCF 860 to be used for the terminal 810. For example, the SMF 830 may select the PCF 860 on the basis of information obtained from an NRF or local configuration. However, no limitation to the embodiment is imposed. Afterward, the SMF 830 may forward an SM policy association establishment request to the PCF 860 for session management policy connection creation. The SM policy association establishment request may include context information, such as a subscription permanent identifier (SUPI), a data network name (DNN), and network slice selection assistance information (NSSAI), but is not limited thereto. The PCF 860 may query a subscriber profile stored in the local configuration or a UDR to determine a policy corresponding to the SUPI, along with PCC rules. The SMF 860 may obtain the determined policy and PCC rules from the PCF 860, and may select at least one UPF on the basis of the policy and PCC rules. This may be the same as shown in FIG. 6.

Herein, for example, the UPF 850 may be registered in the UPMF 840. For example, the UPMF 840 may store, on the basis of a network slice, UPF topology information including all UPFs within the network slice. That is, the UPMF 840 may register all UPFs corresponding to a network slice. The UPMF 840 may store a UPF identifier, a network slice in which UPFs are included, and interface information. In addition, the UPMF 840 may store IP addresses corresponding to the respective all UPFs and link connection information between the UPFs, and may compute, on the basis of the IP addresses and link connection information, a path for current embedded UPFs. As another example, the UPMF may further obtain, on the basis of UPF topology, a DNN identifier and additional information related to UPF registration and store the DNN identifier and additional information. However, no limitation to a particular embodiment is imposed.

Based on the above, UPFs 850 may be registered in the UPMF 840 on the basis of a network slice. Herein, for example, when a particular UPF is not included in UPF topology on the basis of a network slice, the UPF may be deregistered from the UPMF 840. As another example, when a network slice is not used or a particular network slice is not managed by the UPMF 840, the UPMF 840 may terminate the UPFs included in the UPF topology of the network slice. However, no limitation to a particular embodiment is imposed.

The SMF 830 may transmit, on the basis of determined policy and PCC rules, a query for UPF selection to the UPMF 840. The query may include the determined policy, PCC rules, and other types of information related to UPF selection, but no limitation to a particular form is imposed. The UPMF 840 may compute an UPF path on the basis of the information included in the query, and may forward a response to the SMF 830. For example, the response may include, on the basis of the UPF path, UPF topology information and UPF identifier information included in the UPF path. However, no limitation to a particular embodiment is imposed. Afterward, the SMF 830 may transmit a session establishment request to the UPFs 850 in the UPF path, and in response thereto, may obtain a session establishment response. Afterward, the terminal 810 and the RAN may complete PDU session establishment for uplink and downlink.

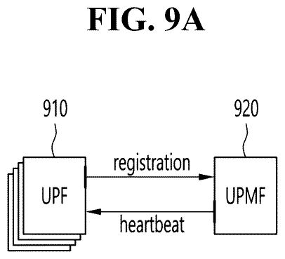

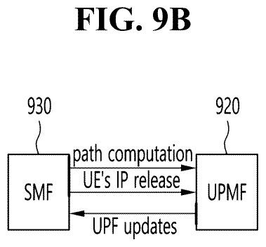

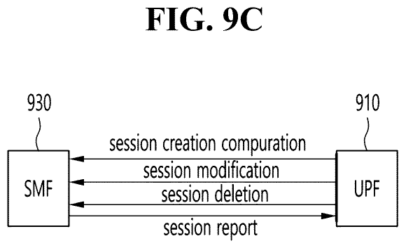

FIGS. 9A to 9C are diagrams illustrating operation methods of an SMF, a UPF, and a UPMF based on an SBI according to an embodiment of the present disclosure. For example, as shown in FIG. 8, when a UPF is managed by the UPMF, the SMF, the UPF, and the UPMF may operate on the basis of the SBI. Herein, referring to FIG. 9A, the UPMF 920 may be a network function that manages at least one UPF 910. The UPMF 920 may forward, to the UPF 910, a registration service request to register a profile of the UPF 910. Reversely, the UPF 910 may forward, to the UPMF 920, information indicating that the UPF 910 is in an operational state. As a specific example, the UPF 910 may forward, to the UPMF 920, a request to register the profile of the UPF 910. The profile of the UPF may include UPF-related configuration information. The UPF-related configuration information may include an UPF identifier, a network slice including the UPF, and interface information, and may further include other types of information. As a specific example, Table 2 below may be UFP-related configuration information. Referring to Table 2, the UPF-related configuration information may include an SBI address for exposing an SBI service, and a network interface for GTP tunneling, but is not limited thereto.

When a registration request is received from the UPF 910, the UPMF 920 may determine the validity of the UPF-related configuration information, and may determine, on the basis of the validity, whether to include the UPF 910 in UPF topology. For example, when a registration request message is valid and a network interface of the UPF and a slice related thereto are validated by the UPMF 920, the UPMF 920 may include the UPF 910 in the UPF topology. Afterward, the UPMF 920 may provide a response to the UPF 910.

As another example, the UPMF 920 may periodically transmit a confirmation message to a registered UPF 910. For example, the confirmation message may be a heartbeat message that periodically checks whether the UPF 910 is in an active state. As another example, the confirmation message may be a registration confirmation request message, but may not be limited to that name. Hereinafter, the following description is based on a confirmation message for convenience of description. The confirmation message may include a nonce value and time stamp values, and through this, the current time of the UPMF 920 may be indicated. The UPF 910 may receive the confirmation message, and transmit a response including the same nonce value and time stamp values to the UPMF 920. For example, the response may be a registration confirmation response message, but may not be limited to that name. In addition, the response message may further include an additional message related to the UPF 910. However, no limitation to a particular embodiment is imposed. That is, the UPMF 920 may periodically exchange messages with the UPF 910 to determine whether registration of the UPF 910 in the UPMF 920 is valid. Herein, when the UPMF 920 does not receive a response message from the UPF 910, the UPMF 920 may transmit a message again after a preset time. When a message is not received after that time, the UPF 910 may be deleted from the UPF topology.

TABLE 2

```
“sbiport”: 8805,
“upmf”: {
    “ip” : “192.168.56.101”,
  “port” : 9800
  },
“iflist” : [
  {
      “ip” : “192.168.0.100”,
        “mtu” : 1400,
        “type” : “n3”,
        “name” : “n3-1”
        “slices” : [
        “slice1”,
            “slice2”
          ]
    },
    {
          “ip” : “192.168.100.101”,
          “mtu” : 1400,
          “type” : “n9”,
          “name” : “n9-2”
        “slices” : [
        “slice1”,
            “slice2”
          ]
    },
```

As another example, referring to FIG. 9B, the SBI-based operation between the UPMF 920 and the SMF 930 may be considered. As a specific example, the SMF 930 may make a request to the UPMF 920 for path computation. The SMF 930 may make a request to the UPMF 920 for path computation for selecting at least one UPF to create GTP tunneling. During establishment of a PDU session, the SMF 930 may select at least one UPF for creating a GTP tunnel from a base station. That is, the SMF 930 may set a UPF path for creating a GTP tunnel. For example, in the current network structure, the SMF 930 may select a UPF from preset UPF topology.

Herein, in the case in which the network operates on the basis of the SBI, at least one UPF may be managed by the UPMF 920 as described above. Since UPF management is performed by the UPMF 920, the SMF 930 may request the UPMF 920 to perform path computation and select a UPF derived by path computation. That is, path computation may be performed by the UPMF 920, and path computation information may be forwarded to the SMF 930. For the above-described operation, the SMF 930 may forward a query for path computation to the UPMF 920. The query for path computation may include a data network identifier, a slice identifier, and information on N3 network in which a base station is located, but may not be limited thereto. When the query is received from the SMF 930, the UPMF 920 may create UPF topology including a UPF with a network interface that provides a requested slice. That is, a network interface that does not provide a requested slice may not be included in the UPF topology.

For example, the UPMF 920 may select an anchoring UPF that includes N9 interface for a requested data network from the UPF topology. Afterward, the UPMF 920 may use the CIDR of the data network to assign an IP address for a terminal, and may compute the shortest path connecting the N3 network of the base station and the anchoring UPF. Herein, the shortest path may include one anchoring UPF. When a path is successfully created, the UPMF 920 may include path information in a response and forward the response to the SMF 930. However, when a path is not successfully created, the UPMF 920 may include path creation failure information in a response and forward the response to the SMF 930.

In addition, when a path is created, the UPMF 920 may maintain the path and an SMF identifier related thereto. For example, when the UPMF 920 recognizes UPF disconnection, the UPMF 920 may indicate information on this to the SMF 930 and the SMF 930 may update the tunnel for the PDU session. That is, the UPMF 920 may make a request to the SMF 930 for a UPF update. In addition, for example, when the SMF 930 deregisters the PDU session, the SMF 930 may forward PDU session deregistration information to the UPMF 920 and the UPMF 920 may deregister the IP address assigned to the terminal.

In addition, for example, referring to FIG. 9C, the SBI-based operation between the SMF 930 and the UPF 910 may be set. For example, the UPF 910 may make a request to the SMF 930 for at least one selected from the group of session establishment, session modification, and session deletion. In addition, the SMF 930 may give the UPF 910 a session report. Herein, for example, all APIs may be derived from corresponding procedures within a packet forwarding control protocol (PFCP). Herein, the PFCP may be a protocol used between a control plane and a user plane, and may be related to packet forwarding. A PFCP message may be changed into http request and response within the SBI, but may not be limited thereto. For example, the PFCP message may include a header and a body. The body of the PFCP message may include session-related information, and the header of the PFCP message may include destination-related information of the message of the PFCP session. Therefore, when the PFCP message is changed into http request and response messages within the SBI, the header and the body may be changed into different forms. Specifically, the PFCP header may be removed, and the header may be changed into a http request/response header. The header of the PFCP message may include a sequence number, and the request and the response may include the same sequence number. For example, the SBI is synchronous, so sequence number information may not be required. In addition, the header of the PFCP message may include an SEID number that represents a session ID at the end point of a session. For example, the end point of the session may be the SMF 930 or the UPF 910. That is, when one end point transmits a PFCP message, a session ID of another end point may be set as the SEID. Herein, when the SBI is used, the SEID may be modeled as a URL parameter of an API. For example, when a PDU session is established, the SMF 930 may start the procedure by transmitting a request without a session ID. Afterward, when the session is created, the UPF 910 may create a local session ID and include the local session ID in a response message and forward the response message to the SMF 930. Herein, the SMF 930 may use the local session ID as a URL parameter of an API.

As another example, a body of a PFCP message may be used in the same form, considering a relationship with an existing PFCP library. The body of the PFCP message may be encoded as an array of bytes using TVL (type, value, and length). Afterward, the array of bytes may be decoded in the same way as it is encoded. Considering the above, when the SBI is used, an array of bytes may be set in a body of a corresponding http request or response. In the SBI, an API itself already implies a data type of a http request/response body and an encoding method, so a method of using this may be required. However, no limitation thereto is imposed.

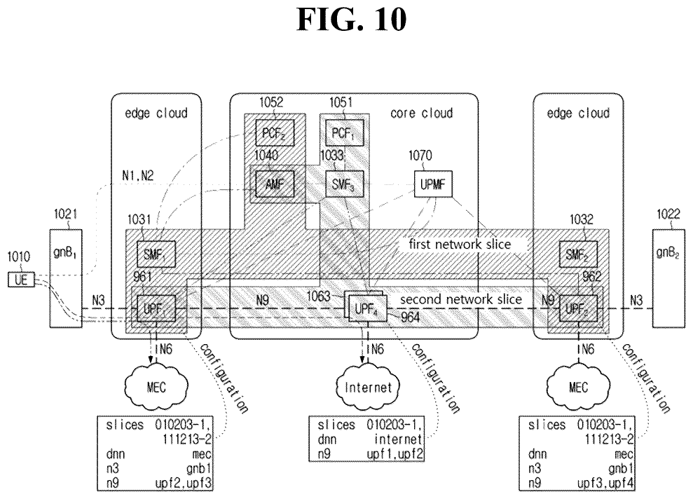

FIG. 10 is a diagram illustrating a method of managing UPFs on the basis of a UPMF according to an embodiment of the present disclosure. Referring to FIG. 10, a network may include a first network slice and a second network slice. However, this is an example for convenience of description, and no limitation thereto is imposed. Specifically, the first network slice may be controlled by SMF1 1031 and SMF2 1032, and may be configured for mobile edge computing (MEC). Herein, the SMF1 1031 and the SMF2 1032 of the first network slice may have edge clouds close to respective base stations 1021 and 1022. In addition, the second network slice may be controlled by SMF3 1033. Herein, the SMF3 1033 may be included in a core cloud. For example, each SMF may be specified on the basis of a PLMN ID, a slice ID, and a network function type. In addition, an AMF 1040 may be shared by the first network slice and the second network slice, and may be specified on the basis of a PLMN ID, an AMF region, an AMF set, and an AMF ID.

In addition, for example, the network shown in FIG. 10 may include four UPFs 1061, 1062, 1063, and 1064, but this is merely a configuration for convenience of description and is not limited thereto. Specifically, UPF1 1061 and UPF2 1062 may be configured in the edge clouds with the respective base stations 1021 and 1022, and may have respective interfaces. Herein, the UPF1 1061 and the UPF2 1062 may use UPF3 1063 and UPF4 1064 provided in the core cloud through N9 interface, which is the interface between the UPFs. Herein, for example, UPF topology information on the above-described UPFs 1061, 1062, 1063, and 1064 may be registered in a UPMF 1070. That is, the UPMF 1070 may store the UPF topology information registered on the basis of the first network slice and the second network slice, and may store information on each interface. In addition, the UPMF 1070 may further include a DNN identifier and other types of information, but no limitation to a particular form is imposed.

In addition, for example, referring to FIG. 10, a terminal 1010 may connect a PDU session for a MEC data network on the basis of the first network slice, and may connect a PDU session for an Internet service on the basis of the second network slice. However, this is an example for convenience of description, and no limitation thereto is imposed. Herein, the terminal 1010 may forward a PDU session establishment request to the AMF 1040, and the AMF 1040 may select the SMF1 1031 close to the base station 1021 to which the terminal 1010 is connected, for PDU session context creation. For example, the SMF1 1031 may obtain policy information and PCC rule information from PCF2 1052 connected thereto for PDU session context creation, and may make a request to the UMPF 1070 for a query. Herein, the query may include either PDU session-related information or network slice-related information or both, but may not be limited thereto. For example, when the terminal 1010 establishes a PDU session for MEC, the UPMF 1070 may configure the UPF1 1061 and the UPF2 1062 as UPFs of the PDU session for MEC in the UPF topology information on the basis of the first network slice, and may derive a path using the UPF2 1062 as the shortest path to provide a response to the SMF1 1031. However, for example, when the terminal 1010 establishes a PDU session for the Internet, the UPMF 1070 may be configured to include, in the UPF topology information, the UPFs 1061, 1062, 1063, and 1064 of the second network slice for the Internet, and may derive a path using the UPF1 1061 and the UPF4 1064 as the shortest path to provide a response to the SMF1 1031. That is, the UMPF 1070 may manage UPF topology on the basis of a network slice, and may derive the shortest path on the basis of the UPF topology and provide the shortest path to the SMF.

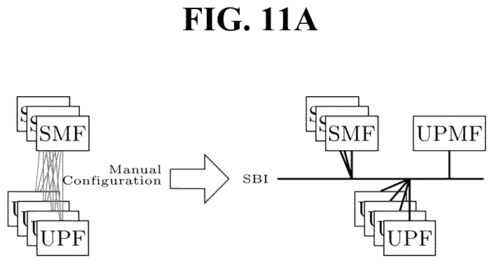

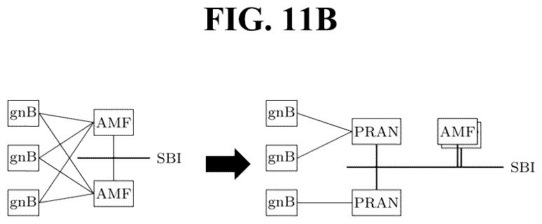

FIGS. 11A and 11B are diagrams illustrating a method of configuring network functions on the basis of a service-based interface applicable to the present disclosure. Referring to FIG. 11A, as network functions, an SMF and a UPF may be connected to each other on the basis of N4 interface, which is a point-to-point interface. Herein, a UPF may be connected on the basis of more complex topology, and change in UPF topology may be required considering resource saving. Considering the above, an SMF and a UPF may be connected to each other on the basis of the SBI. In addition, UPF topology maintenance may be performed by the UPMF, which is as described above.

For example, in the current system, an SMF may need to maintain the UPF topology when controlling data transmission and reception. In addition, when it needs to create a new PDU session for a terminal, an SMF may select at least one UPF to create a GTP tunnel starting from a base station to a data network, and the selected UPF topology may be maintained.

Herein, for example, in the new network structure, a UPF selection procedure may be performed by the UPMF. The UPMF may be a network function of managing and controlling the UPF topology, and may simplify SMF functions as described above. Through this, UPF selection is unified in a central network function, and compatibility between different versions of SMFs may be maintained, which is as described above.

In addition, for example, referring to FIG. 11B, existing base stations may operate in parallel with each AMF, but the operation may be set on the basis of the SBI. For example, a base station may be connected to a corresponding PRAN. A PRAN may be connected to a base station via N2 interface, and may be connected to an AMF via a service-based interface.

As a specific example, considering the above-described interface setting using the SBI, an AMF may include network functions of a default AMF (DAMF), a proxy RAN (PRAN), and a new version AMF (NAMF). That is, the functions in an existing AMF may be separated and performed through respective network functions. For example, hereinafter, these are referred to as the DAMF, the PRAN, and the NAMF, but those names are for convenience of description and are not limited thereto. The DAMF may have a function of performing initial authentication for initial registration. Specifically, when a terminal performs initial registration, a base station may select an AMF for registration. Herein, the DAMF may be an AMF selected for terminal registration. The DAMF may authenticate a terminal, verify allowed NSSAI, and serve the terminal directly. As another example, a DAMF may authenticate a terminal, verify allowed NSSAI, and enable another AMF to be selected. In the above case, the DAMF may provide path re-establishment information to a base station so that a NAS message is forwarded from a terminal to a new AMF.

In addition, for example, a PRAN may configure N2 interface with a RAN, and may be connected to an NAMF with the SBI, which may be as shown in FIG. 11B. That is, a PRAN may perform the operation of switching the interface connected to the RAN to the SBI. For example, a PRAN may operate being integrated with a base station, but no limitation to a particular form is imposed.

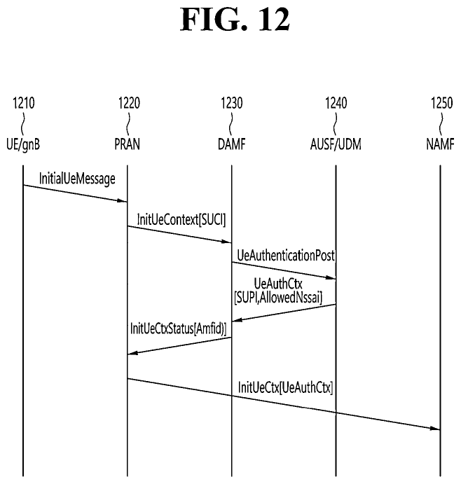

FIG. 12 is a diagram illustrating a method of performing registration based on a service-based interface by a terminal applicable to the present disclosure.

Referring to FIG. 12, a terminal/base station 1210 may forward a message for terminal registration to a PRAN 1220, and the PRAN 1220 may forward terminal context to a DAMF 1230. Herein, the DAMF 1230, which is a default AMF, may be an AMF that performs registration when the terminal is registered to the network. For example, the core network may be unable to recognize in advance which AMF manages terminal authentication and mobility context, so the DAMF 1230 may be first selected as the default AMF and initial authentication may be performed. The DAMF 1230 may obtain SUCI of the terminal through the PRAN 1220, and may use the SUCI to perform authentication through an AUSF/UDM 1240. Afterward, the DAMF 1230 may obtain allowed SNSSAI information from the AUSF/UDM 1240, and may forward the terminal context to the PRAN 1220, thereby completing initial registration.

Herein, the PRAN 1220 may be located between a RAN and a new version AMF (NAMF) 1250. The PRAN 1220 may be connected to the RAN via N2 interface, and may be connected to the NAMF 1250 via the SBI. The PRAN 1220 may convert a NGAP message into http request and response. For example, the PRAN 1220 may serve as an existing AMF from the perspective of a RAN, and may serve as a new type of RAN operating on the basis of the SBI from the perspective of an AMF.

In addition, for example, the NAMF 1250 may not include N2 interface for connection to the RAN, and may be connected to the PRAN 1220 through the SBI. That is, unlike an existing AMF, N2 interface may not be included, and the PRAN 1220 may serve as a proxy in the middle to perform data exchange with the RAN. Herein, the NAMF 1250 may not have the functions of the DAMF 1230. Therefore, the NAMF 1250 may not perform the operation related to terminal context initialization and authentication. The NAMF 1250 may determine that the terminal has been authenticated by the DAMF 1230 before a context initialization request is made. That is, terminal authentication and registration may be controlled by the DAMF 1230, and context and mobility management may be performed by the NAMF 1250 on the basis of the SBI.

Referring to the specific operation shown in FIG. 12, the base station 1210 may transmit a NGAP initial terminal message (NGAP InitialUEMessage) to the PRAN 1220. Herein, the message may be encapsulated in a NAS registration request (NAS RegistrationRequest) of the terminal. The PRAN 1220 may be unable to infer an AMF through the NGAP initial terminal message, and may transmit an initial terminal context request (InitUEContextRequest) to the DAMF 1230. The DAMF 1230 may receive authentication context on the basis of a SUPI from the AUSF/UDM 1240, and may obtain allowed NSSAI information. Afterward, the DAMF 1230 may search an NSSF for an AMF, and may transmit an initial terminal context response (InitUEContextResponse) to the PRAN 1220. Herein, the initial terminal context response may include the authentication context of the terminal, and the PRAN 1220 may transmit the initial terminal context request (InitUEContextRequest) to an assigned AMF (NAMF) 1250. The request may include the terminal authentication context received from the DAMF 1230, and the NAMF 1250 may perform a registration procedure without additional authentication of the terminal. When the NAMF 1250 receives the initial terminal context request (InitUEContextRequest) from the PRAN 1220, the NAMF 1250 may verify the authentication context of the request. Afterward, the NAMF 1250 may determine that terminal authentication has been completed, and may use the received authentication context to perform a security mode setting procedure. Afterward, the NAMF 1250 may create an encryption key for the terminal context, and the base station may create an encryption key for the terminal context. However, when there is no authentication context, an AMF may perform the same type of processing as an existing AMF processes an N2 initial terminal context message (N2 InitUEContextMessage) of the base station. However, no limitation thereto is imposed.

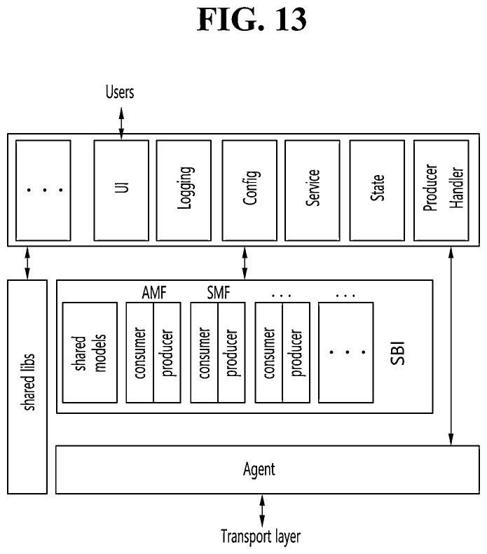

FIG. 13 is a diagram illustrating a general network function design according to an embodiment. Referring to FIG. 13, a network function based on an SBI may include an application layer and a library layer.

Regarding to the application layer and the library layer, a parent layer may include all network functions of the system. In addition, a network function may use an API supported by a child layer to realize business logic.

For example, the child layer may include an SBI module and a shared library. The shared library may include a 5G non-SBI protocol encoding library. The module may include libraries for encoding and decoding protocols used in a network function of the current 5G core architecture, including NAS, NGAP, and PFCP. In addition, some utility functions to help convert data structure between libraries may be included. A library may be an open source package that is realized to be created in a protocol specification using a protocol source code creator, but may not be limited thereto. In addition, the SBI module may expose the SBI to the application layer. Specifically, an API may be defined according to Restful operation defined in the 5G core network function specification, and all APIs may be realized for the following client side and server side. Herein, all network functions may include a consumer API and a producer API, and the module may include a support data structure set for API implementation.

In addition, regarding to the application layer, most network functions may include a plurality of similar modules. For example, a state module may possess a main data structure of an application and may represent the current state of the application. In addition, a producer handler module may realize high-level callbacks to process consumer requests. In addition, a service module may be a main controller of an application, and a configuration module may realize parsing of a configuration file to initialize a network function. In addition, a logging module may realize logger initialization for all modules of a network function, and a UI module may realize command line parsing and may process interactive communication with an external user. However, no limitation thereto is imposed.

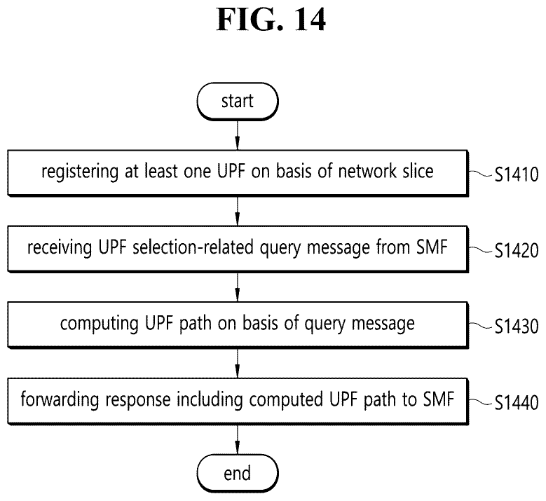

FIG. 14 is a flowchart illustrating an operation method of a network function according to an embodiment. Referring to FIG. 14, a network function may register at least one UPF on the basis of a network slice in step S1410. Herein, the network function may be a UPMF, but is not limited thereto. Afterward, the network function may receive a UPF selection-related query message from the SMF in step S1420. The network function may compute a UPF path on the basis of the query message in step S1430, and may forward a response including the computed UPF path to the SMF in step S1440. Herein, when at least one UPF is registered in the network function, the at least one UPF may forward a registration request message to the network function. The registration request message may include an IP address of the UPF and link information between the UPFs. The network function may store the IP addresses of the respective registered UPFs and the link information between the UPFs. In addition, for example, the registration request message may further include at least one selected from the group of a UPF identifier, a network slice including the UPF, and interface information, which is as described above. The network function may create and store UPF topology information corresponding to the network slice, on the basis of the information included in the registration request message, and may use the UPF topology information to perform the above-described path computation. In addition, the query message received by the network function from the SMF may include at least one selected from the group of NSSAI information, a source network interface as connected base station information, and anchoring UPF information, which is as described above.

In the meantime, an embodiment of the present disclosure is not implemented only through an apparatus and/or a method described so far, and may be implemented through a program that realizes a function corresponding to a configuration of the embodiment of the present disclosure, or through a recording medium on which the program is recorded. This implementation can be easily derived by those skill in the art to which the present disclosure pertains from the description of the embodiment above. Specifically, a method (for example, a network management method, a data transmission method, and a transmission schedule generation method) according to an embodiment of the present disclosure may be implemented in the form of program commands executable through various computer means, and may be recorded on a computer-readable medium. The computer-readable recording medium may include program commands, data files, data structures, and the like separately or in combinations. The program commands recorded on the computer-readable medium may be particularly designed and configured for an embodiment of the present disclosure, or may be known to those skilled in the art of computer software and available. The computer-readable recording medium may include hardware devices configured to store and execute program commands. Examples of the computer-readable recording medium include magnetic media such as hard disks, floppy disks, and magnetic tapes; optical recording media such as CD-ROMs, and DVD-ROMs; magneto-optical media such as floptical disks; ROMs, RAMS, and flash memory. The program commands may include not only machine language codes, which are created by a compiler, but also high-level language codes, which may be executed by a computer by using an interpreter.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A network function for user plane function (UPF) management in a mobile communication system, the network function comprising:
a memory configured to store at least one program therein;
a transceiver configured to transmit and receive at least one signal; and
a processor configured to execute the at least one program stored in the memory,
wherein the processor is configured to
register at least one UPF on the basis of a network slice,
receive a UPF selection-related query message from a session management function (SMF),
compute a UPF path on the basis of the query message, and
forward, to the SMF, a response including the computed UPF path.

2. The network function of claim 1, wherein when the at least one UPF is registered in the network function, the at least one UPF forwards a registration request message to the network function, the registration request message including an Internet protocol (IP) address of the UPF and link information between the UPFs, and
the network function stores the IP addresses of the respective registered UPFs, and the link information between the UPFs.

3. The network function of claim 2, wherein the registration request message further includes at least one selected from a group of an UPF identifier, a network slice including the UPF, and interface information.

4. The network function of claim 3, wherein the network function creates and stores UPF topology information corresponding to the network slice, on the basis of the information included in the registration request message.

5. The network function of claim 4, wherein when the at least one UPF is registered in the network function, the network function transmits a registration confirmation request message to the at least one UPF on the basis of a preset period, and when a registration confirmation response message is received from each of the at least one UPF, registration for each of the at least one UPF is maintained.

6. The network function of claim 5, wherein when the network function does not receive the registration confirmation response message from the UPF to which the registration confirmation request message has been transmitted, the UPF is deregistered from UPF topology.

7. The network function of claim 1, wherein the query message received from the SMF includes at least one selected from a group of network slice selection assistance information (NSSAI), a source network interface as connected base station information, and anchoring UPF information.

8. The network function of claim 1, wherein when the network function determines that the registered UPF is disconnected, information on the disconnected UPF is forwarded to the SMF, and the SMF updates a session on the basis of the information on the disconnected UPF.

9. The network function of claim 1, wherein the network function operates in a network based on a service-based interface (SBI), and a terminal registered in the network based on the SBI forwards a packet to a data network through the UPF path determined by the network function.

10. The network function of claim 9, wherein when the terminal is registered in the network, the terminal is subjected to initial authentication on the basis of a default access and mobility management function (a default AMF, DAMF) through a proxy radio access network (proxy RAN, PRAN), and
when the initial authentication is completed, a connection to a new version AMF (NAMF) is made through the PRAN and a session and mobility are managed.

11. The network function of claim 10, wherein the PRAN is connected through N2 interface to a base station to which the terminal is connected, and is connected to the NAMF through the SBI.

12. A user plane function (UPF) management method performed by a network function in a mobile communication system, the method comprising:
registering at least one UPF on the basis of a network slice;
receiving a UPF selection-related query message from a session management function (SMF);
computing a UPF path on the basis of the query message; and
forwarding, to the SMF, a response including the computed UPF path.

13. The method of claim 12, wherein when the at least one UPF is registered in the network function, the at least one UPF forwards a registration request message to the network function, the registration request message including an Internet protocol (IP) address of the UPF and link information between the UPFs, and
the network function stores the IP addresses of the respective registered UPFs, and the link information between the UPFs.

14. The method of claim 13, wherein the registration request message further includes at least one selected from a group of an UPF identifier, a network slice including the UPF, and interface information.

15. The method of claim 14, wherein the network function creates and stores UPF topology information corresponding to the network slice, on the basis of the information included in the registration request message.
